(19) United States
(12) Patent Application Publication
(10) Pub. No.: US 2014/0139925 A1
(43) Pub. Date: May 22, 2014

(54) COPOLYMER, COMPOSITE PARTICLES CONTAINING COPOLYMER, OPTICAL MATERIAL CONTAINING COMPOSITE PARTICLES, AND OPTICAL ELEMENT CONTAINING OPTICAL MATERIAL

(71) Applicant: Seiji Okada, New Hyde Park, NY (US)

(72) Inventor: Seiji Okada, New Hyde Park, NY (US)

(73) Assignee: CANON KABUSHIKI KAISHA, Tokyo (JP)

(21) Appl. No.: 13/976,380

(22) PCT Filed: Dec. 21, 2011
(86) PCT No.: PCT/JP2011/007149

§ 371 Date: Feb. 5, 2014

(30) Foreign Application Priority Data
Dec. 28, 2010 (JP) 2010-293021

(51) Int. Cl. G02B 1/04

(52) U.S. Cl. CPC G02B 1/041
USPC 359/601; 526/279; 526/277; 525/326.5; 525/326.6; 525/72

(57) ABSTRACT

Copolymers in the related art that could be used as a surface modifier for dispersing inorganic particles in a cyclic olefin polymer require the use of an expensive catalyst such as a palladium compound, which involves high manufacturing costs. Provided is a copolymer that has high affinity for cyclic olefin polymers and that can bind to inorganic particles.

### TECHNICAL FIELD

The present invention relates to copolymers, composite particles containing the copolymers, optical materials containing the composite particles, and optical elements containing the optical materials.

### BACKGROUND ART

Cyclic olefin polymers are known as materials for optical elements such as lenses. If inorganic particles are added to a cyclic olefin polymer, inorganic particles coated with a surface modifier are used so that they do not aggregate with one another. PTL 1 discloses a copolymer composed of structural units derived from bicyclo[2.2.1]hept-2-ene and structural units derived from a particular cyclic olefin compound having a methoxysilyl group. This copolymer, having a methoxysilyl group, binds easily to the surfaces of inorganic particles. In addition, the copolymer has high affinity for cyclic olefin polymers because it has structural units derived from a cyclic olefin compound, which has an alicyclic structure.

### CITATION LIST

### Patent Literature

PTL 1: Japanese Patent Laid-Open No. 2005-126514

### SUMMARY OF INVENTION

According to the findings made by the inventors, the above copolymer could be used as a surface modifier for dispersing inorganic particles in a cyclic olefin polymer. To prepare the copolymer disclosed in PTL 1, however, an expensive catalyst such as a palladium compound needs to be used, which involves high manufacturing costs. A copolymer according to an aspect of the present invention has repeating structural units represented by formulae (1) and (2).

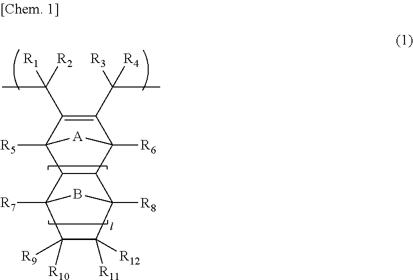

In formula (1), R₁ to R₁₂ are each independently a hydrogen atom or a hydrocarbon group having 1 to 20 carbon atoms. R₉ and R₁₂ optionally combine to form a ring. 1 is an integer of 0 to 2. A and B are each independently selected from —O—, —NH—, —S—, —CH₂—, and —CH₂—CH₂—.

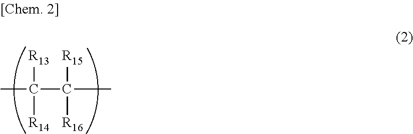

In formula (2), R₁₃ to R₁₆ are each independently selected from a functional group represented by formula (3), a hydrogen atom, a hydrocarbon group having 1 to 5 carbon atoms, and a halogen atom. At least one of R₁₃ to R₁₆ is a functional group represented by formula (3). R₁₄ and R₁₆ optionally combine to form a ring. If two or more of R₁₃ to R₁₆ are functional groups represented by formula (3), the functional groups represented by formula (3) are the same or different.

—(X₁)ᵣ—(Y₁)ₛ—Z₁ (3)

In formula (3), r and s are (r, s)=(1, 1), (1, 0), or (0, 0).

In formula (3), X₁ is a divalent linking group selected from a divalent linking group composed of a compound having a hetero atom and a substituted or unsubstituted arylene group. The substituted arylene group has a functional group having at least one species selected from halogen, oxygen, nitrogen, and silicon atoms or a substituted or unsubstituted hydrocarbon group having 1 to 20 carbon atoms. The substituted hydrocarbon group has a functional group having at least one species selected from halogen, oxygen, nitrogen, and silicon atoms.

In formula (3), Y₁ is a linking group, having a valence of 2 or more, selected from a linking group composed of a substituted or unsubstituted hydrocarbon having 1 to 30 carbon atoms and a linking group composed of a compound having a hetero atom. The substituted hydrocarbon has a functional group having at least one species selected from halogen, oxygen, nitrogen, and silicon atoms.

In formula (3), Z₁ is an alkoxysilyl, alkoxytitanyl, carboxyl, phosphoric acid, phosphonic acid, phosphinic acid, sulfonic acid, sulfinic acid, hydroxyl, thiol, isocyanate, pyridinyl, or amino group.

The copolymer according to this aspect can be manufactured at low cost without using an expensive catalyst because it can be synthesized by anionic polymerization or radical polymerization. In addition, the copolymer according to this aspect has high affinity for cyclic olefin polymers because it has the alicyclic structure represented by formula (1) above. Furthermore, the copolymer according to this aspect can bind to inorganic particles because it has Z₁ in formula (2) above. Accordingly, the copolymer can be used as a surface modifier that can disperse inorganic particles in a cyclic olefin polymer.

Further features of the present invention will become apparent from the following description of exemplary embodiments with reference to the attached drawings.

### BRIEF DESCRIPTION OF DRAWINGS

FIG. 1 is a table summarizing the properties of copolymers prepared in Examples 1 to 6 and Comparative Examples 1 and 2.

FIG. 2 is a table summarizing the properties of composite particles prepared in Examples 7 to 12 and Comparative Examples 1 and 2.

FIG. 3 is a table summarizing the properties of optical elements formed in Examples 13 to 24 and Comparative Example 2.

### DESCRIPTION OF EMBODIMENTS

Exemplary embodiments of the present invention will now be described.

### First Embodiment

### Copolymer

A copolymer according to a first embodiment of the present invention includes repeating structural units represented by formulae (1) and (2).

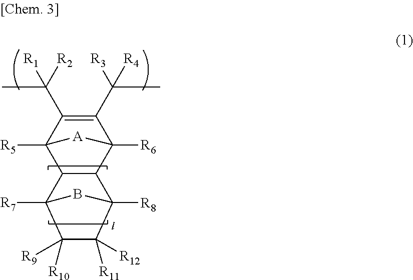

In formula (1), R₁ to R₁₂ are each independently a hydrogen atom or a hydrocarbon group having 1 to 20 carbon atoms. R₉ and R₁₂ optionally combine to form a ring. 1 is an integer of 0 to 2. A and B are each independently selected from —O—, —NH—, —S—, —CH₂—, and —CH₂—CH₂—. If A and B are —CH₂— or —CH₂—CH₂—, the copolymer according to this embodiment exhibits low water absorbency; it can be used for optical elements such as lenses.

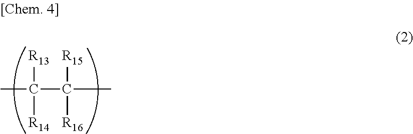

In formula (2), R₁₃ to R₁₆ are each independently selected from a functional group represented by formula (3), a hydrogen atom, a hydrocarbon group having 1 to 5 carbon atoms, and a halogen atom. At least one of R₁₃ to R₁₆ is a functional group represented by formula (3). R₁₄ and R₁₆ optionally combine to form a ring. If two or more of R₁₃ to R₁₆ are functional groups represented by formula (3), the functional groups represented by formula (3) may be the same or different.

—(X₁)ᵣ—(Y₁)ₛ—Z₁ (3)

In formula (3), r and s are (r, s)=(1, 1), (1, 0), or (0, 0).

In formula (3), X₁ is a divalent linking group selected from a divalent linking group composed of a compound having a hetero atom and a substituted or unsubstituted arylene group. As used herein, the term “divalent linking group composed of a compound having a hetero atom” refers to a linking group composed of a compound having an oxygen, sulfur, nitrogen, silicon, or phosphorus atom, including, for example, amide, carbamate, urea, carbonyl, ester, carbonate, ether, thioether, thioester, and thioamide groups. The substituted arylene group has a functional group having at least one species selected from halogen, oxygen, nitrogen, and silicon atoms or a substituted or unsubstituted hydrocarbon group having 1 to 20 carbon atoms. The substituted hydrocarbon group has a functional group having at least one species selected from halogen, oxygen, nitrogen, and silicon atoms.

In formula (3), Y₁ is a linking group, having a valence of 2 or more, selected from a linking group composed of a substituted or unsubstituted hydrocarbon having 1 to 30 carbon atoms and a linking group composed of a compound having a hetero atom. The substituted hydrocarbon has a functional group having at least one species selected from halogen, oxygen, nitrogen, and silicon atoms. Examples of hydrocarbon linking groups include substituted or unsubstituted alkylene, alkenylene, and alkynylene groups. The linking group composed of a hydrocarbon having 1 to 30 carbon atoms may have an aromatic group such as a substituted or unsubstituted benzene, fused polycyclic hydrocarbon, aromatic heterocyclic ring, or fused aromatic heterocyclic ring. As used herein, the term “fused polycyclic hydrocarbon” refers to a fused ring hydrocarbon in which two or more monocyclic rings donate (fuse) one side to each other, including, for example, naphthalene, anthracene, and pyrene. In addition, the term “aromatic heterocyclic ring” refers to an aromatic ring in which at least one of the carbon atoms forming the ring is replaced with a hetero atom such as an oxygen, sulfur, nitrogen, silicon, or phosphorus atom, including, for example, furan, pyrrole, thiophene, oxazole, and pyridine. In addition, the term “fused aromatic heterocyclic ring” refers to a fused ring hydrocarbon in which two or more aromatic heterocyclic rings donate (fuse) one side to each other, including, for example, benzofuran, indole, benzothiophene, and quinoline.

As used herein, the term “linking group composed of a compound having a hetero atom” refers to a linking group composed of a compound having an oxygen, sulfur, nitrogen, silicon, or phosphorus atom, including, for example, imino, amide, carbamate, urea, carbonyl, ester, carbonate, ether, polyoxyethylene, polyoxypropylene, thioether, thioester, thioamide, thiourea, sulfinyl, sulfonyl, phosphoryl, and siloxane groups. If Y₁ is a linking group having a valence of 3 or more, the linking group may be branched and bound to two or more Z₁. If Y₁ has a linear structure, the number of atoms in the main chain of the linear structure may be 1 to 20. If the number of atoms is 1 to 20, the copolymer according to this embodiment, when used for optical elements, varies little in refractive index with temperature change because it has high glass transition temperature and therefore low linear expansion coefficient. As used herein, the term “main chain” refers to the longest contiguous carbon chain in a linear compound.

In formula (3), Z₁ is an alkoxysilyl, alkoxytitanyl, carboxyl, phosphoric acid, phosphonic acid, phosphinic acid, sulfonic acid, sulfinic acid, hydroxyl, thiol, isocyanate, pyridinyl, or amino group.

As used herein, the term “alkoxysilyl group” refers to a functional group represented by formula (4) below where X is a silicon atom, and the term “alkoxytitanyl group” refers to a functional group represented by formula (4) below where X is a titanium atom.

—X(OR₁₇)_{g}R_{18(3-g)} (4)

In formula (4), R₁₇ is a hydrocarbon group having 1 to 10 carbon atoms, and R₁₈ is a hydrogen atom, a halogen atom, or a substituted or unsubstituted hydrocarbon group having 1 to 10 carbon atoms. The substituted hydrocarbon group has a functional group having at least one species selected from halogen, oxygen, nitrogen, and silicon atoms. g is an integer of 1 to 3. If R₁₇ is a hydrocarbon group having 1 to 10 carbon atoms, the copolymer according to this embodiment, when used as a surface modifier, can react efficiently with the inorganic particles to be surface-modified because the alkoxy group hydrolyzes at high rate with little effect of steric hindrance. In particular, Z₁ can be an alkoxysilyl group, which is unlikely to change its structure by accident because it has low reactivity and is therefore resistant to hydrolysis in air.

As used herein, the term “phosphoric acid group” refers to a functional group represented by formula (5) below.

—O—P(═O)(OH)ₕ(OR₁₉)₍₂₋ₕ₎ (5)

In formula (5), R₁₉ is a substituted or unsubstituted hydrocarbon group having 1 to 10 carbon atoms. The substituted hydrocarbon group has a functional group having at least one species selected from halogen, oxygen, nitrogen, and silicon atoms. g is 1 or 2. If R₁₉ is a hydrocarbon group having 1 to 10 carbon atoms, the copolymer according to this embodiment, when used as a surface modifier, can react efficiently with the inorganic particles to be surface-modified because there is little effect of steric hindrance.

As used herein, the term “phosphonic acid group” refers to a functional group represented by formula (6) below.

—P(═O)(OH)ᵢ(OR₂₀)₍₂₋ᵢ₎ (6)

In formula (6), R₂₀ is a substituted or unsubstituted hydrocarbon group having 1 to 10 carbon atoms. The substituted hydrocarbon group has a functional group having at least one species selected from halogen, oxygen, nitrogen, and silicon atoms. i is 1 or 2. If R₂₀ is a hydrocarbon group having 1 to 10 carbon atoms, the copolymer according to this embodiment, when used as a surface modifier, can react efficiently with the inorganic particles to be surface-modified because there is little effect of steric hindrance.

The copolymer according to this embodiment has high affinity for cyclic olefin polymers because its repeating structural units represented by formula (1) above have an alicyclic structure. In addition, the copolymer according to this embodiment, having the repeating structural units represented by formulae (1) and (2) above, can be manufactured at low cost without using an expensive catalyst because it can be synthesized by anionic polymerization or radical polymerization. In addition, the copolymer according to this embodiment can bind to inorganic particles because it has Z₁ in formula (2) above. Accordingly, the copolymer according to this embodiment can be used as a surface modifier that can disperse inorganic particles in a cyclic olefin polymer. Furthermore, the copolymer according to this embodiment offers high design flexibility as a copolymer that can bind to inorganic particles because it may have a functional group having active hydrogen, such as a carboxyl, phosphoric acid, phosphonic acid, phosphinic acid, sulfonic acid, sulfinic acid, hydroxyl, thiol, or amino group.

### Examples of Repeating Structural Units Represented by Formula (1)

Examples of repeating structural units, represented by formula (1), of the copolymer according to this embodiment include those of formulae (1-1) to (1-7) below.

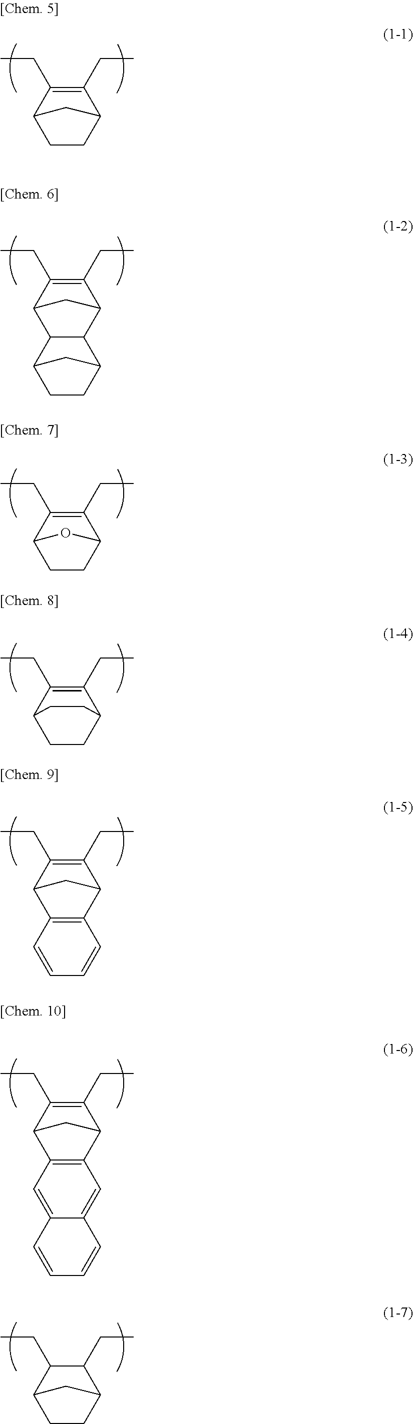

### Examples of Repeating Structural Units Represented by Formula (2)

Examples of repeating structural units, represented by formula (2), of the copolymer according to this embodiment include those of formulae (2-1) to (2-12) below.

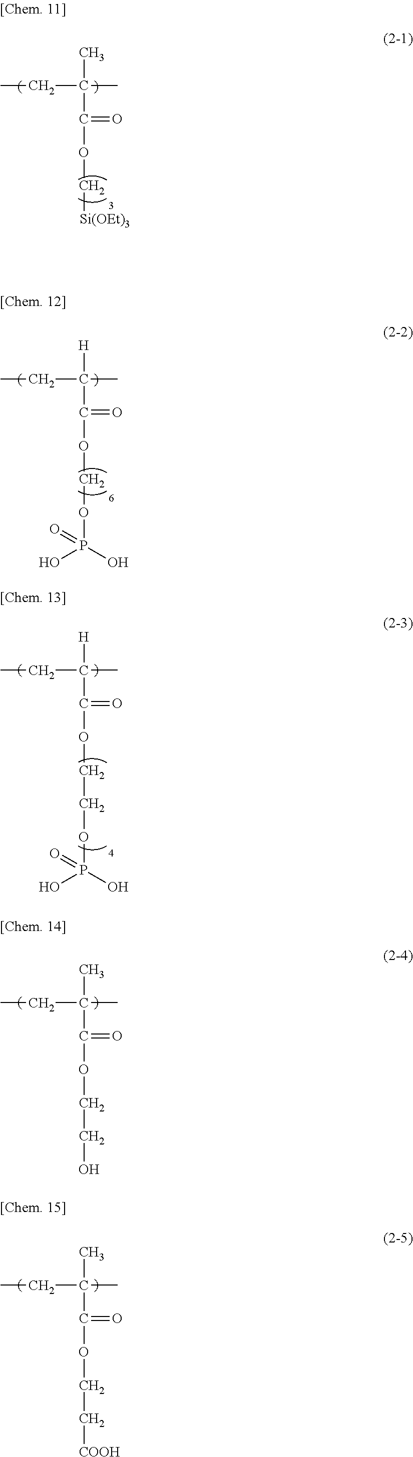

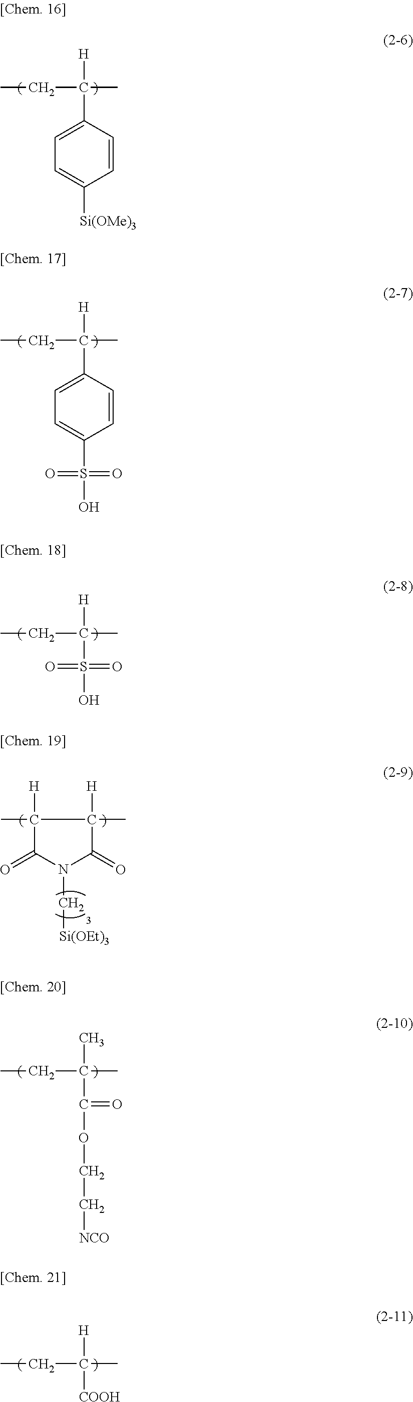

### Other Repeating Structural Units

The copolymer according to this embodiment may have repeating structural units other than those represented by formulae (1) and (2) above. Examples of such repeating structural units include those of formulas (a) to (e) below.

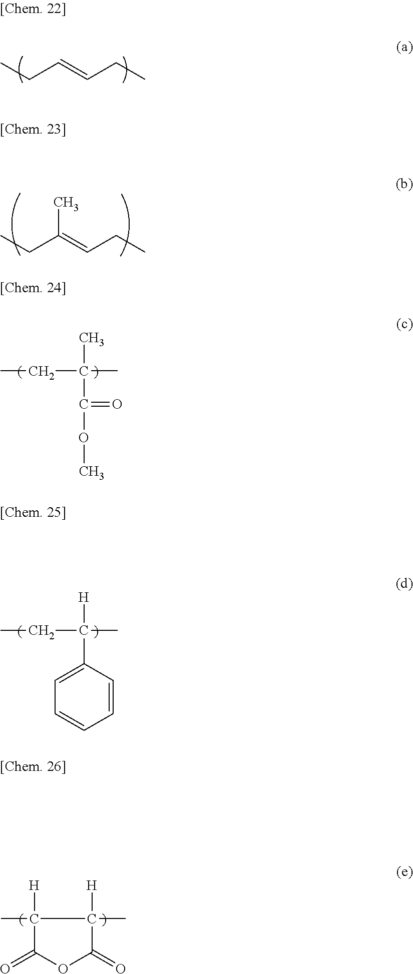

(Example of Copolymer)

An example of the copolymer according to this embodiment is one characterized in that, in formula (1), R₁ to R₁₂ are hydrogen atoms, 1 is 0 or 1, and A and B are each independently selected from —O—, —CH₂—, and —CH₂—CH₂—; in formula (2), R₁₃ to R₁₅ are each independently a hydrogen atom or a methyl group, and R₁₆ is represented by formula (3); in formula (3), X₁ is a divalent linking group selected from amide, carbamate, ester, carbonate, ether, thioether, thioester, and substituted or unsubstituted arylene groups, the substituted arylene group has a functional group having at least one species selected from halogen, oxygen, nitrogen, and silicon atoms or a substituted or unsubstituted hydrocarbon group having 1 to 20 carbon atoms, and the substituted hydrocarbon group has a functional group having at least one species selected from halogen, oxygen, nitrogen, and silicon atoms; Y₁ is a linking group, having a valence of 2 or more, selected from a linking group composed of a substituted or unsubstituted hydrocarbon having 1 to 30 carbon atoms, a linking group composed of a compound having at least one aromatic group, and a linking group composed of a compound having a hetero atom; and Z₁ is an alkoxysilyl, carboxyl, phosphoric acid, phosphonic acid, sulfonic acid, hydroxyl, thiol, isocyanate, or amino group, and r and s are (r, s)=(1, 1), (1, 0), or (0, 0). Such a copolymer can be prepared from easily available or inexpensive materials. In the copolymer according to this embodiment, the molar ratio of the repeating structural units represented by formula (1) to the repeating structural units represented by formula (2) is preferably 50:50 to 99:1, more preferably 60:40 to 95:5. If the molar ratio is 50:50 to 99:1, the proportion of the repeating structural units represented by formula (1), which have high affinity for cyclic olefin polymers, in the repeating structural units of the copolymer is so high that inorganic particles can be easily dispersed in a cyclic olefin polymer.

The copolymer according to this embodiment may be a random copolymer or a block copolymer. If the copolymer according to this embodiment is a random copolymer, a smaller amount of copolymer is required for surface modification of inorganic particles because the repeating structural units represented by formula (2), which can bind to inorganic particles, do not tend to be localized in the copolymer.

### Method for Manufacturing Copolymer

The monomer that forms the repeating structural units represented by formula (1) after polymerization is hereinafter referred to as monomer (A), and the monomer that forms the repeating structural units represented by formula (2) after polymerization is hereinafter referred to as monomer (B). The copolymer according to this embodiment can be prepared by radical polymerization or anionic polymerization of monomers (A) and (B).

For radical polymerization, for example, at least one radical polymerization initiator can be used to initiate polymerization. The radical polymerization initiator used can be a known one. Examples of radical polymerization initiators include azo initiators, peroxide initiators, redox initiators, atom transfer radical polymerization initiators, and nitroxide initiators. In particular, azo initiators and peroxide initiators come in a wide variety of types and therefore allow a suitable one to be selected depending on the types of monomers, are easily available, and are inexpensive. If the amount of radical polymerization initiator used is 0.1 to 20 mole percent of the total number of moles of monomers (A) and (B), the yield of the copolymer is high, and the molecular weight of the copolymer can be easily controlled. Monomers (A) and (B) can also be polymerized by adding, for example, a polymerization accelerator or chain transfer agent such as an amine, thiol, or disulfide to accelerate the polymerization.

For anionic polymerization, for example, at least one organometallic compound can be used. Examples of organometallic compounds used as anionic polymerization initiators include hydrocarbon lithium compounds, such as methyllithium, n-butyllithium, sec-butyllithium, tert-butyllithium, and phenyllithium, and Grignard reagents. Among them, n-butyllithium can be used in terms of availability and cost. There is no particular limitation on the amount of organometallic compound used; however, if the amount of organometallic compound used is 0.1 to 20 mole percent of the total number of moles of monomers (A) and (B), the yield of the copolymer is high, and the molecular weight of the copolymer can be easily controlled.

### Monomer (A)

Monomer (A) may be any monomer that forms the repeating structural units represented by formula (1) after polymerization and that copolymerizes with monomer (B), described later, by anionic polymerization or radical polymerization. Examples of such monomers include cyclic diene monomers disclosed in Canadian Journal of Chemistry vol. 53, pp. 256-262 and Macromolecules 2009, 42, 9268-9274. Among them, 2,3-dimethylenebicyclo[2.2.1]heptane, 2,3-dimethylenebicyclo[2.2.2]octane, 2,3-dimethylenetetracyclo[6.2.1.1^{3,6}.0^{2,7}]dodecane, 2,3-dimethylene-1,4-methano-1,2,3,4-tetrahydronaphthalene, 2,3-dimethylene-1,4-methano-1,2,3,4-tetrahydroanthracene, and 2,3-dimethylene-7-oxabicyclo[2.2.1]heptane can be easily prepared. The copolymer according to this embodiment may also be prepared using a plurality of types of monomers selected from the above monomers.

### Monomer (B)

Monomer (B) may be any monomer that forms the repeating structural units represented by formula (2) after polymerization or a chemical reaction following polymerization, such as oxidation, reduction, or hydrolysis, and that has a functional group capable of copolymerization with monomer (A) above by anionic polymerization or radical polymerization. In particular, monomer (B) may have a functional group that binds to inorganic particles. This eliminates the need for a step of attaching a functional group that binds to inorganic particles to monomer (B) or a compound resulting from polymerization of monomer (B), or a step of converting a functional group, of monomer (B) or a compound resulting from polymerization of monomer (B), that does not bind to inorganic particles into a functional group that binds to inorganic particles. As an example of a step of converting a functional group that does not bind to inorganic particles into a functional group that binds to inorganic particles, the case where monomer (B) is methyl methacrylate will be described. Methyl methacrylate and a compound resulting from polymerization thereof have a methyl ester group, which does not bind to inorganic particles. Therefore, the compound resulting from polymerization of methyl methacrylate is subjected to a reaction that converts the methyl ester group into a carboxyl group by hydrolysis. As a result, the compound attains a carboxyl group, which is a functional group that binds to inorganic particles.

The functional group that binds to inorganic particles may be any functional group that forms a bond, such as a covalent bond, ionic bond, coordinate bond, or hydrogen bond, with inorganic particles, described later. Examples of such functional groups include alkoxysilyl, alkoxytitanyl, carboxyl, phosphoric acid, phosphonic acid, phosphinic acid, sulfonic acid, sulfinic acid, hydroxyl, thiol, isocyanate, pyridinyl, and amino groups.

An alkoxysilyl group is a functional group represented by formula (4) above (where X is a silicon atom). Among them, —Si(OMe)₃, —Si(OEt)₃, —Si(OMe)₂Me, —Si(OEt)₂Me, —Si(OMe)Me₂, and —Si(OEt)Me₂ are easily available, easy to handle, and react easily with inorganic particles, where Me is a methyl group, and Et is an ethyl group.

A phosphoric acid group is a functional group represented by formula (5) above. Among them, —O—PO(OH)₂ is easily available and reacts easily with inorganic particles.

A phosphonic acid group is a functional group represented by formula (6) above. Among them, —PO(OH)₂ is easily available and reacts easily with inorganic particles.

The functional group capable of copolymerization with monomer (A) by anionic polymerization or radical polymerization may be any functional group having a carbon-carbon double bond capable of anionic polymerization or radical polymerization. In view of ease of polymerization, at least one functional group selected from the group consisting of (meth)acryloyl, (meth)acrylamide, vinylamino, vinylamide, styryl, vinyl ether, maleimide, allyl, maleate, fumarate, itaconic acid residue, vinyl ketone, and halogenated vinyl groups. Among them, at least one functional group selected from the group consisting of (meth)acryloyl and styryl groups can be used.

Examples of monomer (B) include methyl (meth)acrylate, 3-methacryloxypropyltrimethoxysilane, 6-acryloyloxyhexyl dihydrogen phosphate, (meth)acrylic acid, maleic anhydride, dibutyl maleate, dibutyl fumarate, vinylacetic acid, 3-(meth)acryloyloxypropyltrimethylsilane, 3-(meth)acryloyloxypropylmethyldimethoxysilane, 3-(meth)acryloyloxypropyltrimethoxysilane, 3-(meth)acryloyloxypropylmethyldiethoxysilane, 3-(meth)acryloyloxypropyltriethoxysilane, p-styryltrimethoxysilane, maleimide, vinylpyrrolidone, N-(3-triethoxysilylpropyl)maleimide, 2-(meth)acryloyloxyethyl dihydrogen phosphate, 3-(meth)acryloyloxypropyl dihydrogen phosphate, 4-(meth)acryloyloxybutyl dihydrogen phosphate, 6-(meth)acryloyloxyhexyl dihydrogen phosphate, 2-(meth)acryloyloxyethyl dihydrogen phosphate, phenyl(2-acryloyloxyethyl)phosphate, acid phosphooxyethyl methacrylate, 3-chloro-2-acid phosphooxypropyl methacrylate, acid phosphooxy polyoxyethylene glycol monomethacrylate, acid phosphooxy polyoxypropylene glycol methacrylate, (meth)acryloyloxy-2-hydroxypropyl acid phosphate, (meth)acryloyloxy-3-hydroxypropyl acid phosphate, (meth)acryloyloxy-3-chloro-2-hydroxypropyl acid phosphate, 3-(meth)acryloyloxypropylphosphonic acid, 4-(meth)acryloyloxybutylphosphonic acid, 5-(meth)acryloyloxypentylphosphonic acid, 6-(meth)acryloyloxyhexylphosphonic acid, 2-acrylamido-2-methylpropanesulfonic acid, 3-allyloxy-2-hydroxypropanesulfonic acid, vinylsulfonic acid, (meth)allylsulfonic acid, styrenesulfonic acid, sulfoethyl (meth)acrylate, sulfopropyl (meth)acrylate, 2-hydroxy-3-butenesulfonic acid, 2-acrylamido-2-methylpropanesulfonic acid, (meth)acryloyloxyethyl isocyanate, 2-carboxyethyl (meth)acrylate, 2-hydroxyethyl (meth)acrylate, (meth)acrylamide, vinylpyridine, vinylaniline, and 2-(tert-butylamino)ethyl methacrylate. The copolymer according to this embodiment may also be prepared using a plurality of types of monomers selected from the above monomers.

### Organic Solvent

Monomers (A) and (B) may be copolymerized in an organic solvent. There is no particular limitation on the organic solvent used therefor, and organic solvents compatible with monomers (A) and (B) can be used, including aliphatic hydrocarbon solvents, aromatic hydrocarbon solvents, ketone solvents, ester solvents, ether solvents, cyclic ether solvents, alcohol solvents, and halogenated solvents. Examples of aliphatic hydrocarbon solvents include pentane, hexane, heptane, decane, and cyclohexane. Examples of aromatic hydrocarbon solvents include benzene, toluene, and xylene. Examples of ketone solvents include acetone, methyl ethyl ketone, methyl isobutyl ketone, and cyclohexanone. Examples of ester solvents include methyl acetate, ethyl acetate, propyl acetate, and butyl acetate. Examples of ether solvents include diethyl ether and dimethoxyethane. Examples of cyclic ether solvents include tetrahydrofuran and dioxane. Examples of alcohol solvents include methanol, ethanol, propanol, isopropanol, butanol, and cyclohexanol. Examples of halogenated solvents include chloroform, 1,2-dichloroethane, methylene chloride, carbon tetrachloride, trichloroethylene, tetrachloroethylene, chlorobenzene, tetrachloroethane, and bromobenzene. Two or more of the above organic solvents can also be mixed.

Monomer Other than Monomers (A) and (B)

The copolymer according to this embodiment may be prepared using a monomer other than monomers (A) and (B) above to adjust the mechanical and thermal properties of the copolymer.

Examples of such monomers include conjugated dienes such as butadiene and isoprene, (meth)acrylic monomers such as methyl (meth)acrylate, maleic anhydride and anhydrous maleimide derivatives, and styrene monomers such as styrene. The copolymer may also be prepared using a plurality of monomers selected from the above monomers.

### Second Embodiment

### Hydrogenated Copolymer

A copolymer according to a second embodiment of the present invention is characterized in that at least some of the repeating structural units, represented by formula (1), that the copolymer according to the first embodiment contains are repeating structural units represented by formula (7) below (hereinafter also referred to as “hydrogenated copolymer”). The repeating structural units represented by formula (7) are repeating structural units represented by formula (1) in which the carbon-carbon double bond is hydrogenated. Hydrogenated copolymers have the advantage of having a higher heat resistance and weather resistance than unhydrogenated copolymers.

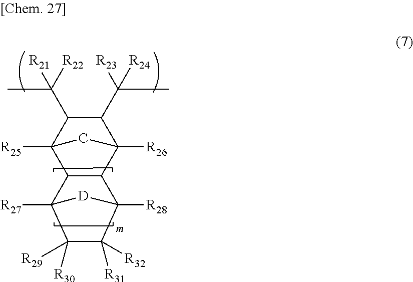

In formula (7), R₂₁ to R₃₂ are each independently a hydrogen atom or a hydrocarbon group having 1 to 20 carbon atoms. R₂₉ and R₃₂ optionally combine to form a ring. m is an integer of 0 to 2. C and D are each independently selected from —O—, —NH—, —S—, —CH₂—, and —CH₂—CH₂—. In the copolymer according to this embodiment, the molar ratio of the repeating structural units represented by formulae (1) and (7) to the repeating structural units represented by formula (2) is preferably 50:50 to 99:1, more preferably 60:40 to 95:5. If the molar ratio is 50:50 to 99:1, the proportion of the repeating structural units represented by formulae (1) and (7), which have high affinity for cyclic olefin polymers, in the repeating structural units of the copolymer is so high that inorganic particles can be easily dispersed in a cyclic olefin polymer.

### Method for Manufacturing Hydrogenated Copolymer

A method for manufacturing the hydrogenated copolymer according to this embodiment will now be described. The hydrogenated copolymer can be produced by hydrogenating the carbon-carbon double bond of a copolymer produced by the above method for manufacturing a copolymer using a known hydrogenation catalyst such as a homogeneous hydrogenation catalyst mainly containing a compound of a transition metal in Groups 8 to 10 of the periodic table and/or a supported hydrogenation catalyst in which a transition metal in Groups 8 to 10 of the periodic table is supported on a support. The hydrogenation specifically means that the copolymer is brought into contact with hydrogen gas to cause a hydrogenation reaction.

The above hydrogenation reaction is carried out in an inert organic solvent. Any inert organic solvent can be selected, and the same organic solvents as those used for preparation of the above copolymer can be used. Among them, the hydrogenated copolymer is highly soluble in alicyclic hydrocarbon solvents, aromatic hydrocarbon solvents, and cyclic ether solvents.

The conditions for the above hydrogenation reaction vary depending on the type of hydrogenation catalyst used. The hydrogenation temperature is typically −20 to 250 degrees Celsius, preferably −10 to 220 degrees Celsius, more preferably 0 to 200 degrees Celsius. The hydrogen pressure is typically 0.01 to 10 MPa, preferably 0.05 to 8 MPa, more preferably 0.1 to 5 MPa. If the hydrogenation temperature is −20 degrees Celsius or higher, the hydrogenation rate is high. If the hydrogenation temperature is 250 degrees Celsius or lower, no side reaction tends to occur. If the hydrogen pressure is 0.01 MPa or higher, the hydrogenation rate is high. If the hydrogen pressure is 10 MPa or lower, no high-pressure reactor is needed, thus requiring a lower equipment cost.

Examples of methods for removing used hydrogenated copolymer include the following methods. If a homogeneous catalyst is used, it can be converted into a metal oxide or salt in the reaction solution after the reaction by adding, for example, an oxidant or basic compound and a solvent poorly soluble in the reaction solution, such as water or methanol, to extract the metal oxide or salt into the poor solvent, followed by removing it through filtration or centrifugation. Alternatively, a homogeneous catalyst can be removed by adsorbing it onto an adsorbent or by extracting it into an acidic aqueous solution such as hydrochloric acid. If a supported hydrogenation catalyst is used, it can be easily removed by centrifugation or filtration.

### Third Embodiment

### Composite Particles

Composite particles according to a third embodiment of the present invention will now be described. The composite particles according to this embodiment are characterized in that the copolymer according to the first or second embodiment is bound to inorganic particles with Z₁. This bond is, for example, a covalent bond, ionic bond, coordinate bond, or hydrogen bond. Among them, a covalent bond allows the copolymer and the inorganic particles to be more resistant to dissociation.

### Inorganic Particles

In this embodiment, the inorganic particles can be formed of silicon oxide, a metal oxide, diamond, a multiple metal oxide, a metal sulfide, a metal compound semiconductor, or a metal. Examples of metal oxides include aluminum oxide, titanium oxide, niobium oxide, tantalum oxide, zirconium oxide, zinc oxide, magnesium oxide, tellurium oxide, yttrium oxide, indium oxide, tin oxide, and indium tin oxide. Examples of multiple metal oxides include lithium niobate, potassium niobate, and lithium tantalate. Examples of metal compound semiconductors include metal sulfides such as zinc sulfide and cadmium sulfide, zinc selenide, cadmium selenide, zinc telluride, and cadmium telluride. Examples of metals include gold. Core-shell inorganic particles can also be used, which are inorganic particles of one type coated with another inorganic component. In addition, the inorganic particles can have any shape, such as a spherical, oval, flat, or rod shape.

The inorganic particles used can be appropriately selected depending on the performance necessary for an optical element, described later. For example, inorganic particles having a high refractive index, such as titanium oxide, niobium oxide, tantalum oxide, zirconium oxide, or diamond particles, can be used in order to improve the refractive index of the optical element described later.

In addition, if the optical element needs transparency, the inorganic particles preferably have an average primary particle size of 30 nm or less, more preferably 10 nm or less, so that they cause less scattering. The average primary particle size herein is the particle size measured by transmission electron microscopy (TEM).

### Examples of Composite Particles

The composite particles according to this embodiment may have the structure represented by formula (8) or (9) below.

M-O-E (8)

M-S—F (9)

In formulae (8) and (9), M is a carbon, silicon, or metal atom in the inorganic particles, O is an oxygen atom, S is a sulfur atom, E is selected from carbon, silicon, phosphorus, sulfur, and nitrogen atoms, and F is a carbon atom.

### Dispersion Aid

To further increase the dispersibility of the inorganic particles, the composite particles according to this embodiment may contain a dispersion aid. In this embodiment, any dispersion aid that has a functional group that binds to the inorganic particles and that is compatible with the organic solvent used in the manufacture of the composite particles, described later, can be used.

Examples of functional groups that bind to the inorganic particles include carboxyl, halogenated acyl, sulfonic acid, sulfinic acid, phosphoric acid, phosphonic acid, phosphinic acid, amino, amide, thiol, alkoxysilyl, halogenated silyl, alkoxytitanyl, and halogenated titanyl groups. Among them, an alkoxysilyl group can be used in terms of availability.

Examples of alkoxysilyl groups include methyltrimethoxysilyl, dimethyldimethoxysilyl, trimethylmethoxysilyl, n-propyltrimethoxysilyl, n-butyltriethoxysilyl, n-hexyltrimethoxysilyl, n-hexyltriethoxysilyl, n-octyltriethoxysilyl, n-decyltrimethoxysilyl, cyclopentyltrimethoxysilyl, phenyltrimethoxysilyl, and diphenyldimethoxysilyl groups.

### Method for Manufacturing Composite Particles

A method for manufacturing the composite particles includes a step of adding the inorganic particles to, for example, an organic solvent and adding the copolymer and optionally the dispersion aid so that the inorganic particles, the copolymer, and the dispersion aid bind to each other (hereinafter also referred to as “surface modification step”). The inorganic particles used may be in a solid state or be dispersed in a liquid, that is, in a sol state. The surface modification step can be carried out by a technique such as ultrasonic treatment, the use of a bead mill, ball mill, or jet mill, or stirring.

The organic solvent used may be any solvent in which the copolymer is soluble. Examples of such solvents include aliphatic hydrocarbon solvents such as pentane, hexane, heptane, decane, and cyclohexane; aromatic hydrocarbon solvents such as benzene, toluene, and xylene; ketone solvents such as methyl ethyl ketone, methyl isobutyl ketone, and cyclohexanone; cyclic ether solvents such as tetrahydrofuran and dioxane; and halogenated solvents such as chloroform, 1,2-dichloroethane, methylene chloride, carbon tetrachloride, trichloroethylene, tetrachloroethylene, chlorobenzene, tetrachloroethane, and bromobenzene. Two or more of the above organic solvents can also be selected and used as a mixture.

The amount of inorganic particles added in the above surface modification step may be 1% to 50% of the weight of the organic solvent. This means that if the amount of organic solvent is 100 g, the amount of inorganic particles added may be 1% of 100 g, namely, 1 g, to 50% of 100 g, namely, 50 g. This meaning of weight percent applies hereinafter. If the amount of inorganic particles added is 1% by weight or more, the productivity of the inorganic particles is high. If the amount of inorganic particles added is 50% by weight or less, the decrease in stirring efficiency due to increased viscosity of the reaction solution is small, and accordingly the surface modification time of the inorganic particles is short.

The amount of copolymer added in the surface modification step may be 10% or more of the weight of the inorganic particles so that the inorganic particles are readily dispersed in the organic solvent.

In addition, an acid or base may be added to improve the reactivity of the surfaces of the inorganic particles with the copolymer and the dispersion aid (hereinafter also referred to as “additive”). The additive may be any additive that does not dissolve the inorganic particles. Examples of such additives include hydrochloric acid, sulfuric acid, nitric acid, organic carboxylic acids, organic sulfonic acids, ammonia (including aqueous ammonia), organic amines, and hydroxides of alkali metals and alkaline earth metals, such as sodium hydroxide and potassium hydroxide. The amount of additive added is preferably 0.01% to 20%, more preferably 0.1% to 10%, of the total weight of the copolymer and the dispersion aid. If the amount of additive added is 0.01% by weight or more, the reactivity of the surfaces of the inorganic particles with the copolymer and the dispersion aid is high. On the other hand, if the amount of additive added is 20% by weight or less, the additive can easily be removed after the surface modification step.

If an organic solvent is used in the surface modification step, the composite particles are dispersed in the organic solvent; they can be obtained in a solid state by evaporating the organic solvent or mixing another organic solvent which is compatible with the organic solvent and in which the copolymer is poorly soluble (reprecipitation).

Optionally, a step of purification by removing copolymer and dispersion aid unbound to the surfaces of the inorganic particles may be added. The purification may be carried out by any process, such as ultrafiltration, centrifugation, or reprecipitation.

Composite particles having the above hydrogenated copolymer can be produced by binding the hydrogenated copolymer to the inorganic particles or hydrogenating the copolymer bound to the composite particles by the method described in the “Method for Manufacturing Hydrogenated Copolymer” section.

The dispersion of the composite particles in the organic solvent can be directly used for hydrogenation of the copolymer or preparation of an optical material, described later.

### Fourth Embodiment

### Optical Material

An optical material according to a fourth embodiment of the present invention will now be described. The optical material according to this embodiment contains the above composite particles. An example of the optical material according to this embodiment is characterized in that it contains a transparent resin and the above composite particles and that the proportion of the transparent resin to the composite particles is 10% to 20,000% by weight, preferably 10% to 2,000% by weight.

The transparent resin may be any commonly used transparent resin, such as an amorphous thermoplastic resin. Examples of transparent resins include acrylic, cyclic olefin, polycarbonate, polyester, polyether, polyamide, and polyimide resins. Among them, cyclic olefin resins can be used taking into account optical properties and water absorbency. Examples of cyclic olefin resins include, but not limited to, ZEONEX (from Zeon Corporation), APEL (from Mitsui Chemicals, Inc.), ARTON (from JSR Corporation), and TOPAS (from Polyplastics Co., Ltd.). An example of TOPAS (from Polyplastics Co., Ltd.) is TOPAS 5013 (from Polyplastics Co., Ltd.). If the copolymer in the composite particles itself is a transparent thermoplastic resin, no other transparent resin needs to be added. Another example of the optical material according to this embodiment is one containing no or an extremely small amount (0% to less than 10% of the weight of the composite particles) of transparent resin. Such an optical material can be prepared by subjecting the composite particles, in a solid state or as a mixture with an extremely small amount of transparent resin, to a heating process such as vacuum hot pressing. Still another example of the optical material according to this embodiment is one in which the composite particles are crosslinked. The composite particles can be crosslinked by removing ethylene from the repeating structural units represented by formula (1) through a retro-Diels-Alder reaction with heat and then dimerizing it through a Diels-Alder reaction to link the copolymer on different composite particles, or if the copolymer has an alkoxysilyl group in formula (2), by subjecting alkoxysilyl groups unbound to the inorganic particles to a sol-gel reaction to link the copolymer on different composite particles. The composite particles can also be crosslinked using, for example, a known crosslinking aid. The optical material can be examined for its crosslinked state by, for example, ¹H-NMR.

This optical material can be manufactured at low cost because it uses a copolymer that can be manufactured at low cost without using an expensive catalyst.

A further example of the optical material according to this embodiment is one in which the copolymer is crosslinked. The copolymer may be the copolymer according to the first embodiment or the hydrogenated copolymer according to the second embodiment. The copolymer can be crosslinked by the same method as above.

### Method for Manufacturing Optical Material

The optical material according to this embodiment can be manufactured by, for example, kneading the composite particles and the transparent resin by shearing using a hot-melt kneading machine, or by mixing the composite particles and the composite particles in an organic solvent and reprecipitating them using a poor solvent.

The optical material according to this embodiment may optionally contain commonly used resin additives, including antioxidants, neutralizers, lubricants, antistatic agents, whitening agents, heat stabilizers, light stabilizers, plasticizers, colorants, impact resistance improvers, extenders, release agents, foaming agents, and processing aids. Examples of such additives include those disclosed in R. Gachter and H. Muller, Plastics Additives Handbook, 4th edition, 1993.

Various types of resin additives can be used alone or in combination as long as the composite particles are compatible with and dispersible in the transparent resin.

### Fifth Embodiment

### Optical Element

An optical element according to a fifth embodiment of the present invention will now be described. The optical element according to this embodiment contains the above optical material and has an optical surface. Examples of optical elements used as optical lenses and prisms include imaging lenses for cameras; lenses such as microscope, endoscope, and telescope lenses; total light transmission lenses such as eyeglass lenses; pickup lenses for optical discs such as CD, CD-ROM, WORM (write once, read many), MO (rewritable optical disk; magneto-optical disk), MD (MiniDisc), and DVD (digital versatile disc); lenses for scanning optical systems, including laser scanning systems, such as F-theta lenses for laser beam printers and lenses for sensors; and prism lenses for camera viewfinder systems. Other applications include light guide plates such as those for liquid crystal displays; optical films such as polarization films, retardation films, and diffusion films; light diffusers; optical cards; and liquid crystal display device substrates.

Among the above examples, the optical element according to this embodiment can be used as a lens. An antireflection coating can be disposed on a surface of the lens, and an intermediate layer can be disposed therebetween. Any antireflection coating can be used; for example, one having a refractive index close to that of the lens can be used. In addition, any intermediate layer can be used; for example, one formed of a material whose refractive index falls between the refractive indices of the lens and the antireflection coating can be used. The surface of the lens refers to a surface that the lens has. The antireflection coating can be disposed on all surfaces, some surfaces, or part of a surface of the lens, for example, at least on a main surface of the lens.

### Method for Manufacturing Optical Element

A method for manufacturing the optical element according to this embodiment using the above optical material will now be described. The optical element is manufactured by preparing the optical material and then molding the resulting optical material. Any molding process can be selected depending on the intended shape of the optical element. Examples of molding processes include injection molding, transfer molding, blow molding, rotational molding, vacuum molding, extrusion molding, calender molding, solution casting, hot press molding, inflation molding, and solvent casting.

The molded product, namely, the optical element, can be used in various forms, including spheres, rods, plates, cylinders, tubes, fibers, films, and sheets.

As an example of the optical element, a method for manufacturing an optical lens will now be described. The optical lens is formed by molding the optical material into a desired lens shape. Any molding process can be used; for example, hot-melt molding can be used in order to form a molded product with superior properties such as low birefringence, high mechanical strength, and high dimensional accuracy. Hot-melt molding can be carried out by, for example, press molding, extrusion molding, or injection molding. Among them, injection molding has high molding ability and productivity.

The molding conditions are selected depending on the intended use and the molding process. For example, the temperature of the optical material in injection molding can be 100 to 400 degrees Celsius. Within the above temperature range, the optical material has appropriate flowability during molding, which reduces sink marks and strain in the molded product, silver streaks due to thermal decomposition of the optical material, and yellowing of the molded product.

### EXAMPLES

The present invention will now be described in more detail with reference to the examples below, although the invention is not limited thereto. The molar ratio, number average molecular weight (Mn), and weight average molecular weight (Mw) of the repeating structural units in the copolymers of Examples and Comparative Examples, namely, formulae (1-1), (1-7), (2-1), and (2-2), and the volume average particle size were measured by the following methods.

### Molar Ratio of Repeating Structural Units in Copolymer

¹H-NMR and ³¹P-NMR were carried out (the solvent used for both measurements was CDCl₃) using a JNM-ECA-400 nuclear magnetic resonance apparatus (from JEOL Ltd.).

### Number Average Molecular Weight and Weight Average Molecular Weight

A gel permeation chromatography (GPC) system (from Waters Corporation) was equipped with two Shodex LF-804 columns (from Showa Denko K.K.) in series, and the number average molecular weight and the weight average molecular weight were measured with a differential refractive index (RI) detector at 40 degrees Celsius using tetrahydrofuran (THF) as a developing solvent. The number average molecular weight and the weight average molecular weight were measured against polystyrene standards.

### Volume Average Particle Size

The volume average particle size was measured using a ZETASIZER Nano-S dynamic light scattering particle size distribution analyzer (from Malvern Instruments Ltd.).

### Transparency Evaluation of Optical Elements

The optical elements (films) produced in Examples 13 to 24 and Comparative Example 3 were visually evaluated for transparency, where the optical elements were evaluated as not being transparent (“poor”) if they looked cloudy and as being transparent (“good”) if they did not look cloudy.

### Example 1

### Synthesis of Copolymer P1

Put into a nitrogen-purged 50 mL two-necked flask containing a magnetic stirrer were 5.0 g (41.6 mmol) of 2,3-dimethylenebicyclo[2.2.1]heptane, 0.5 g (2.0 mmol) of 3-methacryloxypropyltrimethoxysilane, and as a polymerization initiator, 215 mg (1.3 mmol) of 2,2′-azobis(isobutyronitrile) (hereinafter referred to as “AIBN”). The flask was sealed with a glass stopper and was immersed in an oil bath at 80 degrees Celsius to perform a polymerization reaction with stirring for 24 hours. The polymerization was stopped by cooling the flask and bringing the polymerization solution in the flask into contact with air. The resulting copolymer was diluted with 50 mL of THF, and the diluted solution was added dropwise to 500 mL of methanol to recover a precipitate of copolymer P1. The recovered copolymer was dried in a vacuum at 40 degrees Celsius overnight to yield 3.74 g (yield: 68%) of copolymer P1. The number average molecular weight Mn of copolymer P1 was 6.10*10³, and the weight average molecular weight Mw was 1.67*10⁴. The molar ratio of the repeating structural units in copolymer P1 was: repeating structural unit represented by formula (1-1): repeating structural unit represented by formula (2-1)=95:5.

The product was determined to be copolymer P1 from the ¹H-NMR spectrum data shown in Table 1 below, where the protons assigned from their chemical shifts are denoted in italics.

TABLE 1
¹H NMR (400 MHz CDCl₃)

| δ ppm | Assigned proton |
|---|---|
| 0.59-0.76 | —O—CH₂—CH₂—CH₂—Si— |
| 0.86-1.08 | >CH—CH₂—CH<, >CH—CH₂—CH₂—CH< |
| 1.09-1.16 | —CH₃ |
| 1.15-1.40 | >CH—CH₂—CH< |
| 1.47-1.60 | >CH—CH₂—CH₂—CH< |
| 1.63-1.68 | —CH₂—C(CH₃)— |
| 1.69-1.90 | —O—CH₂—CH₂—CH₂—Si— |
| 1.91-2.35 | —CH₂—C═C—CH₂— |
| 2.56-2.79 | >CH—CH₂—CH₂—CH< |
| 3.52-3.61 | —O—CH₃ |
| 3.97-4.05 | —O—CH₂—CH₂—CH₂—Si— |

### Example 2

### Synthesis of Copolymer P2

The same procedure as in Example 1 was carried out except that 1.0 g (4.0 mmol) of 3-methacryloxypropyltrimethoxysilane and 225 mg (1.4 mmol) of AIBN were used in the polymerization reaction to yield 3.99 g (yield: 66.5%) of copolymer P2. The number average molecular weight Mn of copolymer P2 was 55.2*10³, and the weight average molecular weight Mw was 38.0*10⁴. The product was determined to be copolymer P2 from the fact that ¹H-NMR spectrum data having the same peak positions as in Example 1, only with differences in integrated intensity, was obtained. The molar ratio of the repeating structural units in copolymer P2 was: repeating structural unit represented by formula (1-1): repeating structural unit represented by formula (2-1)=92:8.

### Example 3

### Synthesis of Copolymer P3

The same procedure as in Example 1 was carried out except that 1.5 g (6.0 mmol) of 3-methacryloxypropyltrimethoxysilane and 250 mg (1.5 mmol) of AIBN were used in the polymerization reaction to yield 4.55 g (yield: 70%) of copolymer P3. The number average molecular weight Mn of the copolymer P3 was 61.3*10³, and the weight average molecular weight Mw was 62.5*10⁴. The product was determined to be copolymer P3 from the fact that ¹H-NMR spectrum data having the same peak positions as in Example 1, only with differences in integrated intensity, was obtained. The molar ratio of the repeating structural units in copolymer P3 was: repeating structural unit represented by formula (1-1): repeating structural unit represented by formula (2-1)=88:12.

### Example 4

### Synthesis of Copolymer P4

The same procedure as in Example 1 was carried out except that 3.0 g (25.0 mmol) of 2,3-dimethylenebicyclo[2.2.1]heptane, 3.0 g (12.1 mmol) of 3-methacryloxypropyltrimethoxysilane, and 183 mg (1.1 mmol) of AIBN were used in the polymerization reaction to yield 3.41 g (yield: 56.8%) of copolymer P4. The number average molecular weight Mn of copolymer P4 was 9.57*10³, and the weight average molecular weight Mw was 3.00*10⁴. The product was determined to be copolymer P4 from the fact that ¹H-NMR spectrum data having the same peak positions as in Example 1, only with differences in integrated intensity, was obtained. The molar ratio of the repeating structural units in copolymer P4 was: repeating structural unit represented by formula (1-1): repeating structural unit represented by formula (2-1)=64:36.

### Example 5

### Synthesis of Copolymer P5

The same procedure as in Example 1 was carried out except that 3.0 g (25.0 mmol) of 2,3-dimethylenebicyclo[2.2.1]heptane, 0.91 g (3.61 mmol) of 6-acryloyloxyhexyl dihydrogen phosphate instead of 3-methacryloxypropyltrimethoxysilane, 183 mg (1.1 mmol) of AIBN, and 10 mL of THF were used in the polymerization reaction to yield 1.02 g (yield: 26.1%) of copolymer P5. The number average molecular weight Mn of copolymer P5 was 5.03*10³, and the weight average molecular weight Mw was 3.94*10⁴. The molar ratio of the repeating structural units in copolymer P5 was: repeating structural unit represented by formula (1-1): repeating structural unit represented by formula (2-2)=90:10.

The product was determined to be copolymer P5 from the ¹H-NMR spectrum data shown in Table 2 and ³¹P-NMR spectrum data shown in Table 3 below, where the protons assigned from their chemical shifts are denoted in italics.

TABLE 2
¹H NMR (400 MHz CDCl₃)

| δ ppm | Assigned proton |
|---|---|
| 0.90-1.12 | >CH—CH₂—CH<, >CH—CH₂—CH₂—CH< |
| 1.20-1.49 | >CH—CH₂—CH< |
| 1.37-1.47 | —O—CH₂—CH₂—CH₂—CH₂—CH₂—CH₂—O—P— |
| 1.49-1.62 | >CH—CH₂—CH₂—CH< |
| 1.53-1.75 | —O—CH₂—CH₂—CH₂—CH₂—CH₂—CH₂—O—P— |
| 1.80-1.89 | —CH₂—CH— |
| 1.94-2.35 | —CH₂—C═C—CH₂— |
| 2.36-2.58 | —CH₂—CH— |
| 2.55-2.81 | >CH—CH₂—CH₂—CH< |
| 3.92-4.15 | —O—CH₂—CH₂—CH₂—CH₂—CH₂—CH₂—O—P— |

TABLE 3
³¹P NMR (162 MHz CDCl₃)
δ ppm
2.60

### Example 6

### Synthesis of Hydrogenated Copolymer (P6) from Copolymer P2

Put into a stirrer-equipped 500 mL autoclave were 5.0 g of copolymer P2 prepared in Example 2, 0.1 g of 5% Pd/C, and 50 g of cyclohexane. The autoclave was sealed and was purged with nitrogen several times. After the autoclave was purged with hydrogen several times, a hydrogenation reaction was performed at a hydrogen pressure of 4.5 MPa and a temperature of 150 degrees Celsius for six hours. After cooling, the reaction solution was filtered and diluted with 350 mL of cyclohexane. The diluted reaction solution was added to 2 L of 2-propanol with vigorous stirring to precipitate copolymer P6 and was filtered to recover copolymer P6. The recovered copolymer was dried in a vacuum drier at 50 degrees Celsius overnight to yield 4.9 g (yield: 98%) of copolymer P6, which was white. The number average molecular weight Mn of copolymer P6 was 59.8*10³, and the weight average molecular weight Mw was 40.1*10⁴. Table 4 shows ¹H-NMR spectrum data for copolymer P6, where the protons assigned from their chemical shifts are denoted in italics. It was determined that a hydrogenation reaction proceeded from the fact that the ¹H-NMR spectrum data showed new peaks around 1.1 to 1.4 ppm and 1.7 to 1.8 ppm that were not found in the data for copolymer P2. The hydrogenation rate was 62%. The molar ratio of the repeating structural units in copolymer P6 was: repeating structural unit represented by formula (1-1): repeating structural unit represented by formula (1-7): repeating structural unit represented by formula (2-1)=35:57:8.

TABLE 4
¹H NMR (400 MHz CDCl₃)

| δ ppm | Assigned proton |
|---|---|
| 0.61-0.75 | —O—CH₂—CH₂—CH₂—Si— |
| 0.96-1.07 | >CH—CH₂—CH<, >CH—CH₂—CH₂—CH< |
| 1.09-1.16 | —CH₃ |
| 1.18-1.55 | —CH₂—CH(CH<)—CH(CH<)—CH₂—, >CH—CH₂—CH< |
| 1.57-1.67 | >CH—CH₂—CH₂—CH< |
| 1.63-1.69 | —CH₂—C(CH₃)— |
| 1.70-1.95 | —O—CH₂—CH₂—CH₂—Si, —CH₂—CH<, >CH—CH< |
| 1.91-2.37 | —CH₂—C═C—CH₂— |
| 2.62-2.78 | >CH—CH₂—CH₂—CH< |
| 3.54-3.59 | —O—CH₃ |
| 3.95-4.10 | —O—CH₂—CH₂—CH₂—Si |

### Example 7

### Synthesis of Ta2O5/P1 Composite Particles

A mixture of 1.0 g of Ta₂O₅ particles, 3.0 g of copolymer P1, 0.5 g of NEt₃, and 25 g of THF was put into a 100 mL vessel and was subjected to pretreatment using a bead mill (RMB from Aimex Co., Ltd.) at a rotational speed of 650 rpm for 10 minutes. After the pretreatment, 104 g of zirconia beads 30 micrometers in diameter were further added to perform main treatment at a rotational speed of 1,600 rpm for 360 minutes. The resulting slurry was filtered to remove the zirconia beads, thus obtaining a THF dispersion of Ta₂O₅ particles coated with copolymer P1 (hereinafter referred to as “Ta₂O₅/P1 composite particles”). Coarse particles were removed from the dispersion by centrifugation using a centrifuge. The volume average particle size of the Ta₂O₅/P1 composite particles contained in the supernatant liquid after centrifugation was measured to be 75 nm. The supernatant liquid was added dropwise to 200 mL of methanol to recover a precipitate of Ta₂O₅/P1 composite particles. The recovered Ta₂O₅/P1 composite particles were dried in a vacuum at 40 degrees Celsius overnight to yield 3.5 g of Ta₂O₅/P1 composite particles.

### Example 8

### Synthesis of Ta2O5/P2 Composite Particles

The same procedure as in Example 7 was carried out except that copolymer P1 was replaced with copolymer P2. The volume average particle size of Ta₂O₅ particles coated with copolymer P2 (Ta₂O₅/P2 composite particles) contained in the supernatant liquid after centrifugation was 8 nm, and 3.4 g of Ta₂O₅/P2 composite particles were yielded.

### Example 9

### Synthesis of Ta2O5/P3 Composite Particles

The same procedure as in Example 7 was carried out except that copolymer P1 was replaced with copolymer P3. The volume average particle size of Ta₂O₅ particles coated with copolymer P3 (Ta₂O₅/P3 composite particles) contained in the supernatant liquid after centrifugation was 11 nm, and 3.3 g of Ta₂O₅/P3 composite particles were yielded.

### Example 10

### Synthesis of Ta2O5/P4 Composite Particles

The same procedure as in Example 7 was carried out except that copolymer P1 was replaced with copolymer P4. The volume average particle size of Ta₂O₅ particles coated with copolymer P4 (Ta₂O₅/P4 composite particles) contained in the supernatant liquid after centrifugation was 13 nm, and 3.0 g of Ta₂O₅/P4 composite particles were yielded.

### Example 11

### Synthesis of Ta2O5/P5 Composite Particles

The same procedure as in Example 7 was carried out except that the amount of Ta₂O₅ particles was changed to 400 mg, copolymer P1 was replaced with 1.0 g of copolymer P5, and the amount of NEt₃ was changed to 0 g. The volume average particle size of Ta₂O₅ particles coated with copolymer P5 (Ta₂O₅/P5 composite particles) contained in the supernatant liquid after centrifugation was 10 nm, and 1.2 g of Ta₂O₅/P5 composite particles were yielded.

### Example 12

### Synthesis of Ta2O5/P6 Composite Particles

The same procedure as in Example 7 was carried out except that copolymer P1 was replaced with copolymer P6. The volume average particle size of Ta₂O₅ particles coated with copolymer P6 (Ta₂O₅/P6 composite particles) contained in the supernatant liquid after centrifugation was 13 nm, and 3.3 g of Ta₂O₅/P6 composite particles were yielded.

### Examples 13 to 18

### Formation of Optical Element (1)

The Ta₂O₅/P1 to Ta₂O₅/P6 composite particles prepared in Examples 7 to 12 were hot-pressed in a vacuum at 100 degrees Celsius and a pressure of 20 MPa using an IMC-11FA vacuum hot press (from Imoto Machinery Co., Ltd.) for five minutes to form films having a thickness of 100 micrometers. All the resulting films were highly transparent without cloudiness due to aggregation of particles.

### Examples 19 to 24

### Formation of Optical Element (2)

Added to 5.0 g of a 10 wt % toluene solution of TOPAS 5013 (from Polyplastics Co., Ltd.), which is a transparent resin, were 500 mg of each of the Ta₂O₅/P1 to Ta₂O₅/P6 composite particles prepared in Examples 7 to 12. These solutions were stirred for one hour and were added dropwise to 200 mL of methanol to recover precipitates of composite materials of the Ta₂O₅/P1 to Ta₂O₅/P6 composite particles and TOPAS 5013. The recovered composite materials were dried in a vacuum at 40 degrees Celsius overnight to yield composite materials of the Ta₂O₅/P1 to Ta₂O₅/P6 composite particles and TOPAS 5013. These composite materials were hot-pressed in a vacuum at 180 degrees Celsius and a pressure of 20 MPa using an IMC-11FA vacuum hot press (from Imoto Machinery Co., Ltd.) for five minutes to form films having a thickness of 100 micrometers. All the resulting films were highly transparent without cloudiness due to aggregation of particles. It turned out that the Ta₂O₅/P1 to Ta₂O₅/P6 composite particles prepared in Examples 7 to 12 were highly dispersible in cyclic olefin polymers.

### Comparative Example 1

### Synthesis of Homopolymer (P7) of 2,3-Dimethylenebicyclo[2.2.1]Heptane

The same procedure as in Example 1 was carried out using 3 g (25.0 mmol) of 2,3-dimethylenebicyclo[2.2.1]heptane and 150 mg (0.9 mmol) of AIBN to yield 1.75 g (yield: 58.3%) of homopolymer P7. The number average molecular weight Mn of homopolymer P7 was 67.5*10³, and the weight average molecular weight Mw was 12.6*10⁴.

### Synthesis of Ta2O5/P7 Composite Particles

The same procedure as in Example 7 was carried out except that copolymer P1 was replaced with homopolymer P7, although the Ta₂O₅ particles were not dispersed, and no Ta₂O₅/P7 composite particles Ta₂O₅ particles were yielded.

### Comparative Example 2

### Synthesis of Homopolymer (P8) of 3-Methacryloxypropyltrimethoxysilane

The same procedure as in Example 1 was carried out using 3 g (12.1 mmol) of 3-methacryloxypropyltrimethoxysilane and 80 mg (0.5 mmol) of AIBN to yield 2.5 g (yield: 83.3%) of homopolymer P8. The number average molecular weight Mn of homopolymer P8 was 53.3*10³, and the weight average molecular weight Mw was 8.81*10⁴.

### Synthesis of Ta2O5/P8 Composite Particles

The same procedure as in Example 7 was carried out except that copolymer P1 was replaced with homopolymer P8. The volume average particle size of Ta₂O₅ particles coated with homopolymer P8 (Ta₂O₅/P8 composite particles) contained in the supernatant liquid after centrifugation was 12 nm, and 3.3 g of Ta₂O₅/P8 composite particles were yielded.

### Comparative Example 3

### Formation of Optical Element

A film was formed using a composite material of the Ta₂O₅/P8 composite particles and TOPAS 5013 by the same method as in Examples 19 to 24. The resulting film looked cloudy, and a film having Ta₂O₅/P8 composite particles uniformly dispersed therein was not formed.

The above results of Examples and Comparative Examples above demonstrate that the copolymers of Examples can be easily prepared without using an expensive organotransition metal catalyst such as a palladium catalyst and that a functional group having active hydrogen, which is difficult to introduce using a catalyst such as a palladium catalyst, can be easily introduced into the copolymers. The results also demonstrate that the copolymers of Examples serve effectively as a surface modifier to disperse inorganic particles in an organic solvent or resin, allowing the inorganic particles coated therewith to be highly dispersible in cyclic olefin polymers.

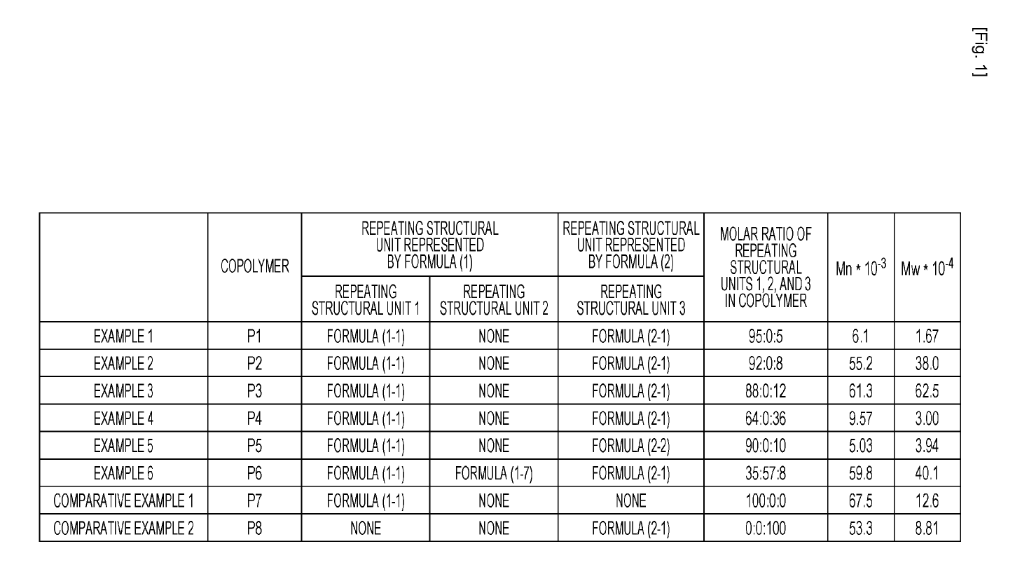

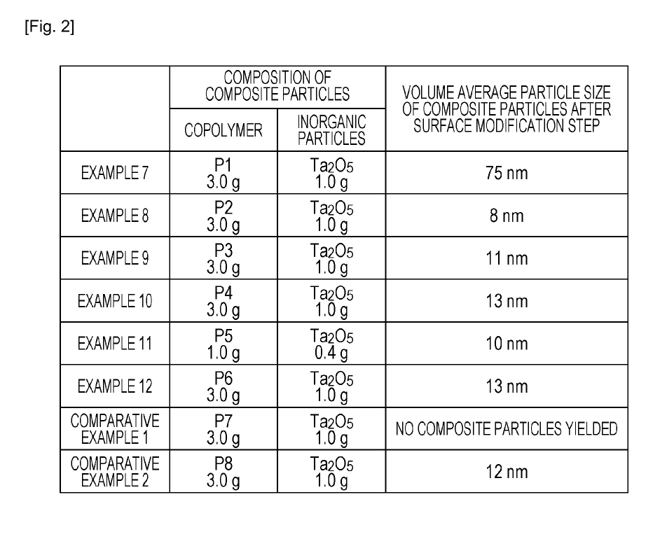

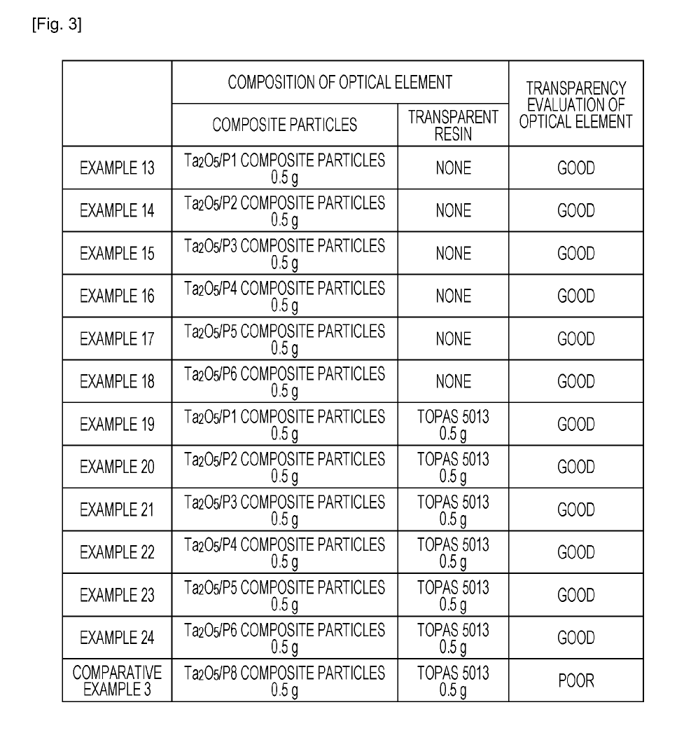

The above results are summarized in FIGS. 1 to 3.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-293021, filed Dec. 28, 2010, which is hereby incorporated by reference herein in its entirety.

1. A copolymer comprising repeating structural units represented by formulae (1) and (2): 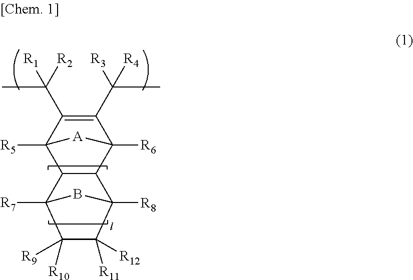
wherein R₁ to R₁₂ are each independently a hydrogen atom or a hydrocarbon group having 1 to 20 carbon atoms, R₉ and R₁₂ optionally combine to form a ring, I is an integer of 0 to 2, and A and B are each independently selected from —O—, —NH—, —S—, —CH₂—, and —CH₂—CH₂—; and 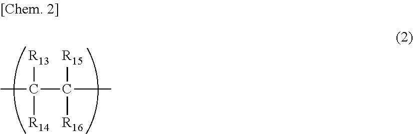
wherein R₁₃ to R₁₆ are each independently selected from a functional group represented by formula (3), a hydrogen atom, a hydrocarbon group having 1 to 5 carbon atoms, and a halogen atom, at least one of R₁₃ to R₁₆ is a functional group represented by formula (3), R₁₄ and R₁₆ optionally combine to form a ring, and, if two or more of R₁₃ to R₁₆ are functional groups represented by formula (3), the functional groups represented by formula (3) are the same or different:
—(X₁)ᵣ—(Y₁)ₛ—Z₁ (3)
wherein r and s are (r, s)=(1, 1), (1, 0), or (0, 0);
wherein X₁ is a divalent linking group selected from a divalent linking group comprising a compound having a hetero atom and a substituted or unsubstituted arylene group, the substituted arylene group having a functional group having at least one species selected from halogen, oxygen, nitrogen, and silicon atoms or a substituted or unsubstituted hydrocarbon group having 1 to 20 carbon atoms, the substituted hydrocarbon group having a functional group having at least one species selected from halogen, oxygen, nitrogen, and silicon atoms;
wherein Y₁ is a linking group, having a valence of 2 or more, selected from a linking group comprising a substituted or unsubstituted hydrocarbon having 1 to 30 carbon atoms and a linking group comprising a compound having a hetero atom, the substituted hydrocarbon having a functional group having at least one species selected from halogen, oxygen, nitrogen, and silicon atoms; and
wherein Z₁ is an alkoxysilyl, alkoxytitanyl, carboxyl, phosphoric acid, phosphonic acid, phosphinic acid, sulfonic acid, sulfinic acid, hydroxyl, thiol, isocyanate, pyridinyl, or amino group.

2. The copolymer according to claim 1, wherein in formula (1), R₁ to R₁₂ are hydrogen atoms, I is 0 or 1, and A and B are each independently selected from —O—, —CH₂—, and —CH₂—CH₂—;
in formula (2), R₁₃ to R₁₅ are each independently a hydrogen atom or a methyl group, and R₁₆ is represented by formula (3);
in formula (3), X₁ is a divalent linking group selected from amide, carbamate, ester, carbonate, ether, thioether, thioester, and substituted or unsubstituted arylene groups, the substituted arylene group having a functional group having at least one species selected from halogen, oxygen, nitrogen, and silicon atoms or a substituted or unsubstituted hydrocarbon group having 1 to 20 carbon atoms, the substituted hydrocarbon group having a functional group having at least one species selected from halogen, oxygen, nitrogen, and silicon atoms;
Y₁ is a linking group, having a valence of 2 or more, selected from a linking group comprising a substituted or unsubstituted hydrocarbon having 1 to 30 carbon atoms, a linking group comprising a compound having at least one aromatic group, and a linking group comprising a compound having a hetero atom; and
Z₁ is an alkoxysilyl, carboxyl, phosphoric acid, phosphonic acid, sulfonic acid, hydroxyl, thiol, isocyanate, or amino group, and r and s are (r, s)=(1, 1), (1, 0), or (0, 0).

3. The copolymer according to claim 1, wherein the molar ratio of the repeating structural units represented by formula (1) to the repeating structural units represented by formula (2) is 50:50 to 99:1.

4. The copolymer according to claim 1, wherein at least some of the repeating structural units, represented by formula (1), that the copolymer contains are repeating structural units represented by formula (7): 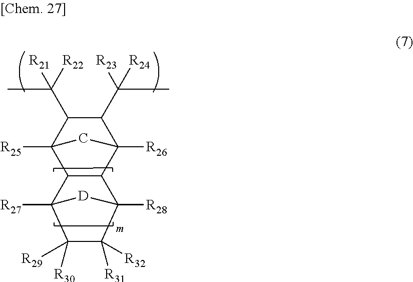
wherein R₂₁ to R₃₂ are each independently a hydrogen atom or a hydrocarbon group having 1 to 20 carbon atoms, R₂₉ and R₃₂ optionally combine to form a ring, m is an integer of 0 to 2, and C and D are each independently selected from —O—, —NH—, —S—, —CH₂—, and —CH₂—CH₂—.

5. Composite particles comprising the copolymer according to claim 1 and inorganic particles to which the copolymer is bound with Z₁ in formula (3).

6. The composite particles according to claim 5, wherein the inorganic particles comprise silicon oxide, a metal oxide, diamond, a multiple metal oxide, a metal sulfide, a metal compound semiconductor, or a metal.

7. The composite particles according to claim 6, wherein the composite particles have a structure represented by formula (8) or (9):
M-O-E (8)
M-S—F (9)
wherein M is a carbon, silicon, or metal atom in the inorganic particles, O is an oxygen atom, S is a sulfur atom, E is selected from carbon, silicon, phosphorus, sulfur, and nitrogen atoms, and F is a carbon atom.

8. An optical material comprising the composite particles according to claim 5.

9. The optical material according to claim 8, further comprising a transparent resin, wherein the proportion of the transparent resin to the composite particles is 10% to 20,000% by weight.

10. An optical material comprising the copolymer according to claim 1, wherein the copolymer is crosslinked.

11. An optical material comprising the composite particles according to claim 5, wherein the composite particles are crosslinked.

12. An optical element comprising the optical material according to claim 8 and having an optical surface.

13. A lens comprising the optical element according to claim 12 and an antireflection coating disposed on the optical element.
